(19) United States
(12) Patent Application Publication
(10) Pub. No.: US 2005/0086622 A1
(43) Pub. Date: Apr. 21, 2005

(54) Hybrid quadratic placement with multiple linear system solvers

(75) Inventors: Charles Jay Alpert, Round Rock, TX (US); Gi-Joon Nam, Austin, TX (US); Paul Gerard Villarrubia, Austin, TX (US)

Correspondence Address: Jack V. Musgrove, 2911 Briona Wood Lane, Cedar Park, TX, 78613, US

(73) Assignee: INTERNATIONAL BUSINESS MACHINES CORPORATION, ARMONK, NY (US)

(21) Appl. No.: 10/687,246

(22) Filed: Oct. 16, 2003

(51) Int. Cl. G06F 9/45

(52) U.S. Cl. 716/9; 716/7

(57) ABSTRACT

A method of designing a layout of an integrated circuit first places logic cells in an initial region of the integrated circuit using a first placement algorithm then, after partitioning the initial region into two or more partitioned regions, uses a second placement algorithm (different from the first placement algorithm) to place a portion of the logic cells in at least one of the partitioned regions. The placement algorithms are preferably quadratic placement algorithms such as the conjugate gradient placement algorithm and the successive over-relaxation placement algorithm. The selection of the particular placement algorithm to be used may be based on, e.g., the cut level or the number moveable objects for the given partition region.

### BACKGROUND OF THE INVENTION

1. Field of the Invention

The present invention generally relates to the fabrication and design of semiconductor chips and integrated circuits, more specifically to a method of designing the physical layout (placement) of logic cells in an integrated circuit and the wiring (routing) of those cells, and particularly to the use quadratic placement algorithms in designing circuit layouts.

2. Description of the Related Art

Integrated circuits are used for a wide variety of electronic applications, from simple devices such as wristwatches, to the most complex computer systems. A microelectronic integrated circuit (IC) chip can generally be thought of as a collection of logic cells with electrical interconnections between the cells, formed on a semiconductor substrate (e.g., silicon). An IC may include a very large number of cells and require complicated connections between the cells. A cell is a group of one or more circuit elements such as transistors, capacitors, resistors, inductors, and other basic circuit elements grouped to perform a logic function. Cells types include, for example, core cells, scan cells and input/output (I/O) cells. Each of the cells of an IC may have one or more pins, each of which in turn may be connected to one or more other pins of the IC by wires. The wires connecting the pins of the IC are also formed on the surface of the chip. For more complex designs, there are typically at least four distinct layers of conducting media available for routing, such as a polysilicon layer and three metal layers (metal-1, metal-2, and metal-3). The polysilicon layer, metal-1, metal-2, and metal-3 are all used for vertical and/or horizontal routing.

An IC chip is fabricated by first conceiving the logical circuit description, and then converting that logical description into a physical description, or geometric layout. This process is usually carried out using a “netlist,” which is a record of all of the nets, or interconnections, between the cell pins. A layout typically consists of a set of planar geometric shapes in several layers. The layout is then checked to ensure that it meets all of the design requirements, particularly timing requirements. The result is a set of design files known as an intermediate form that describes the layout. The design files are then converted into pattern generator files that are used to produce patterns called masks by an optical or electron beam pattern generator. During fabrication, these masks are used to pattern a silicon wafer using a sequence of photolithographic steps. The component formation requires very exacting details about geometric patterns and separation between them. The process of converting the specifications of an electrical circuit into a layout is called the physical design.

The present invention is directed to an improved method for designing the physical layout (placement) and wiring (routing) of cells. Cell placement in semiconductor fabrication involves a determination of where particular cells should optimally (or near-optimally) be located on the surface of a integrated circuit device. Due to the large number of components and the details required by the fabrication process, physical design is not practical without the aid of computers. As a result, most phases of physical design extensively use computer aided design (CAD) tools, and many phases have already been partially or fully automated. Automation of the physical design process has increased the level of integration, reduced turn around time and enhanced chip performance.

Placement algorithms are typically based on either a simulated annealing, top-down cut-based partitioning, or analytical paradigm (or some combination thereof). Recent years have seen the emergence of several new academic placement tools, especially in the top-down partitioning and analytical domains. The advent of multilevel partitioning as a fast and extremely effective algorithm for min-cut partitioning has helped spawn a new generation of top-down cut-based placers. A placer in this class partitions the cells into either two (bisection) or four (quadrisection) regions of the chip, then recursively partitions each region until a global coarse placement is achieved.

FIGS. 1A-1C illustrate a typical placement process according to the prior art. First, a plurality of the logic cells 2 are placed using the entire available region of the IC 4 as shown in FIG. 1A. After initial placement, the chip is partitioned, in this case, via quadrisection, to create four new regions. At the beginning of the partitioning phase some cells may overlap the partition boundaries as seen in FIG. 1B. The cell locations are then readjusted to assign each cell to a given region as shown in FIG. 1C. The process then repeats iteratively for each region, until the number of cells in a given region reaches some preassigned value, e.g., one. While FIGS. 1A-1C illustrate the placement of only seven cells, the number of cells in a typical IC can be in the hundreds of thousands, and there may be dozens of iterations of placement and partitioning.

Analytical placers may allow cells to temporarily overlap in a design. Legalization is achieved by removing overlaps via either partitioning or by introducing additional forces and/or constraints to generate a new optimization problem. The classic analytical placers, PROUD and GORDIAN, both iteratively use bipartitioning techniques to remove overlaps.

Analytical placers optimally solve a relaxed placement formulation, such as minimizing total quadratic wire length. Quadratic placers thus attempt to minimize the sum of squared wire-lengths of a design according to the formula:
Φ(x)=Σ(Xᵢ−Xⱼ)²
in both the horizontal and vertical directions. It can be shown that this optimization is equivalent to minimizing Φ(x) according to the formula:
Φ(x)=½x^{T}Ax−b^{T}x+c
where A is a matrix, x and b are vectors, and c is a scalar constant. Setting the derivative of this function to zero obtains the minimum value:
dΦ(x)/dx=0.
Using the equivalent function, this last equation simplifies to the linear system
Ax=b.
The solution to this linear system determines the initial locations of objects in the given placement region. This linear system can be solved using various numerical optimization techniques. Two popular techniques are known as conjugate gradient (CG) and successive over-relaxation (SOR). The PROUD placer uses the SOR technique, while the GORDIAN placer employs the CG algorithm. In general, CG is known to be more computationally efficient than SOR with a better convergence rate, but CG takes more central processing unit (CPU) time per iteration.

As device technology enters the new deep sub-micron (DSM) era, the role of placement has become more important, and more difficult. The complexity of IC designs in the DSM realm has been growing significantly mainly due to reduced device sizes. It is estimated that the number of transistors per chip will be over 1.6 billion by the year 2016. The current maximum number of objects readily handled by existing placement tools is in the range of tens of millions. While these existing placement tools could conceivably be used to find acceptable solutions with more than 10 million objects, it would likely take an unbearably long time to arrive at those solutions. Thus, current placement tools lack the scalability necessary to handle the ever-increasing number of objects in IC designs. Unfortunately, performance (i.e., quality assurance) and scalability contradict each other. Obtaining higher quality placement solutions requires more CPU time. It would, therefore, be desirable to devise an improved placement method which would allow the designer to control the balance between placement solution quality and runtime considerations to find an optimal or near-optimal solution.

### SUMMARY OF THE INVENTION

It is therefore one object of the present invention to provide an improved method of placing logic cells on an integrated circuit (IC) chip.

It is another object of the present invention to provide such a method which allows an IC designer to find a suitable trade-off between placement solution quality and CPU runtime.

It is yet another object of the present invention to provide such a method which can utilize multiple quadratic placement solutions.

The foregoing objects are achieved in a method of designing a layout of an integrated circuit, generally comprising the steps of first placing a plurality of logic cells in an initial region of the integrated circuit using a first placement algorithm, partitioning the initial region into two or more partitioned regions, and second placing a portion of the logic cells in at least one of the partitioned regions using a second placement algorithm which is different from the first placement algorithm. The placement algorithms are preferably quadratic placement algorithms. The first placement algorithm is more computationally efficient than the second placement algorithm, i.e., requires less processing time. For example, the first placement algorithm may be a conjugate gradient placement algorithm, and the second placement algorithm may be a successive over-relaxation placement algorithm. The invention further contemplates the use of additional placement algorithms for various cut levels in the iterative partitioning procedure. The selection of the particular placement algorithm to be used may be based on, e.g., the cut level or the number moveable objects for the given partition region.

The above as well as additional objectives, features, and advantages of the present invention will become apparent in the following detailed written description.

### BRIEF DESCRIPTION OF THE DRAWINGS

The present invention may be better understood, and its numerous objects, features, and advantages made apparent to those skilled in the art by referencing the accompanying drawings.

FIGS. 1A-1C are plan views of an integrated circuit chip, illustrating a typical prior art placement and partitioning process for laying out the design of an integrated circuit;

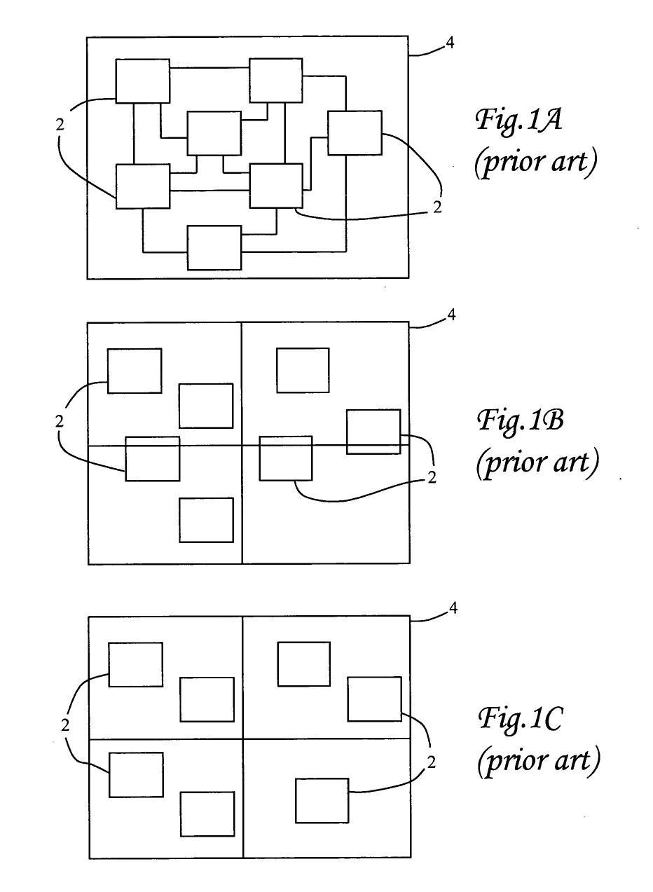

FIG. 2 is a block diagram of a computer system programmed to carry out computer-aided design of an integrated circuit in accordance with one implementation of the present invention;

FIG. 3 is a pictorial representation of placement and partitioning according to one implementation of the present invention wherein higher-level cuts are placed using one numerical technique (conjugate gradient) while lower-level cuts are placed using another numerical technique (successive over-relaxation); and

FIG. 4 is a chart illustrating the logical flow according to one implementation of the present invention.

The use of the same reference symbols in different drawings indicates similar or identical items.

### DESCRIPTION OF THE PREFERRED EMBODIMENT(S)

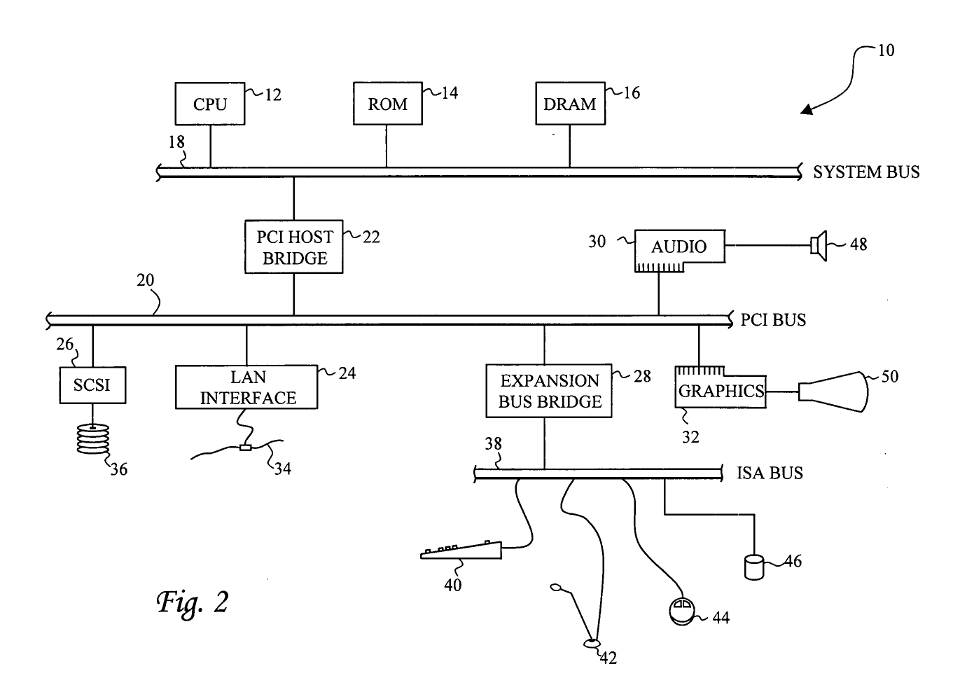

With reference now to the figures, and in particular with reference to FIG. 2, there is depicted one embodiment 10 of a computer system programmed to carry out computer-aided design of an integrated circuit in accordance with one implementation of the present invention. System 10 includes a central processing unit (CPU) 12 which carries out program instructions, firmware or read-only memory (ROM) 14 which stores the system's basic input/output logic, and a dynamic random access memory (DRAM) 16 which temporarily stores program instructions and operand data used by CPU 12. CPU 12, ROM 14 and DRAM 16 are all connected to a system bus 18. There may be additional structures in the memory hierarchy which are not depicted, such as on-board (L1) and second-level (L2) caches.

CPU 12, ROM 14 and DRAM 16 are also coupled to a peripheral component interconnect (PCI) local bus 20 using a PCI host bridge 22. PCI host bridge 22 provides a low latency path through which processor 12 may access PCI devices mapped anywhere within bus memory or I/O address spaces. PCI host bridge 22 also provides a high bandwidth path to allow the PCI devices to access DRAM 16. Attached to PCI local bus 20 are a local area network (LAN) adapter 24, a small computer system interface (SCSI) adapter 26, an expansion bus bridge 28, an audio adapter 30, and a graphics adapter 32. LAN adapter 24 may be used to connect computer system 10 to an external computer network 34, such as the Internet. A small computer system interface (SCSI) adapter 26 is used to control high-speed SCSI disk drive 36. Disk drive 36 stores the program instructions and data in a more permanent state, including the program which embodies the present invention as explained further below. Expansion bus bridge 28 is used to couple an industry standard architecture (ISA) expansion bus 38 to PCI local bus 20. As shown, several user input devices are connected to ISA bus 38, including a keyboard 40, a microphone 42, and a graphical pointing device (mouse) 44. Other devices may also be attached to ISA bus 38, such as a CD-ROM drive 46. Audio adapter 30 controls audio output to a speaker 48, and graphics adapter 32 controls visual output to a display monitor 50, to allow the user to carry out the integrated circuit design as taught herein.

While the illustrative implementation provides the program instructions embodying the present invention on disk drive 36, those skilled in the art will appreciate that the invention can be embodied in a program product utilizing other computer-readable media, including transmission media.

Computer system 10 carries out program instructions for placement of cells in the design of an integrated circuit, using a novel technique wherein different quadratic algorithms are used at different stages in the iterative process. Accordingly, the program may include conventional aspects of various quadratic optimizers and cut-based partitioners, and these details will become apparent to those skilled in the art upon reference to this disclosure. In the exemplary embodiment, computer system 10 is programmed to utilize the conjugate gradient (CG) quadratic algorithm for higher-level cuts, and utilize the successive over-relaxation (SOR) quadratic algorithm for lower-level cuts. By applying the CG or SOR techniques in a selective manner to the same IC layout, a high-quality placement solution can be derived in much less time than would otherwise be required.

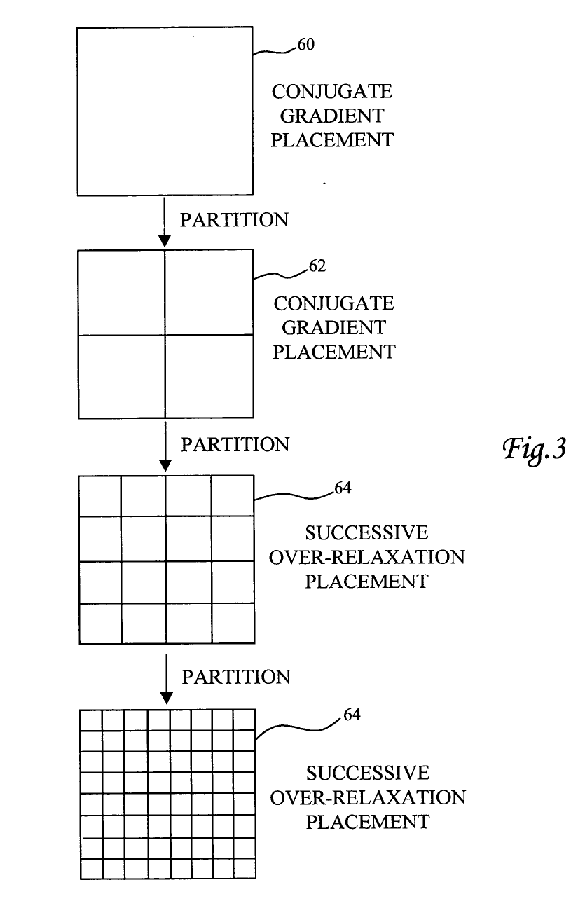

Referring now to FIG. 3, in the exemplary implementation the CG algorithm is used for the top-level (cut level 1) cut 60, and the next successive cut (cut level 3) 62 wherein there are four regions or bins in the chip area. The SOR algorithm is used for subsequent lower-level cuts 64 and 66 (cut levels 5 and below, i.e., 16 or more bins). In other words, the process begins with conjugate gradient placement of cells when the bin is initially set to the entire chip region, followed by partitioning. Partitioning could be bisection, but the exemplary implementation utilizes quadrisection partitioning. After this first partitioning, conjugate gradient placement is again used, followed by further partitioning. Thereafter, successive over-relaxation is employed for placement, again followed by further partitioning. This procedure is run recursively on each bin until eventually all of the cells are in their own bins, and the placement is legal. The global placement is followed by a detailed placement which sets the exact coordinates of each object subject to row and slot constraints. While FIG. 3 illustrates only four placement operations, those skilled in the art will appreciate that many additional placement iterations can occur.

The implementation of FIG. 3 may also be expressed in pseudo-code as follows:

B = Ø
add entire_chip_area to B
while (any bin ∈ B has more objects than threshold )

for each bin ∈ B with more objects than threshold

extract bin from B
construct linear equation Ax = b
if ( cut_level <= CG_limit )

solve the linear system with CG

else

solve the linear system with SOR

do bisection or quadrisection
add sub-bins to B

end for

end while
do detailed placement.

The point at which the system switches over from using the CG algorithm to using the SOR algorithm may be set by the designer using different parameters, such as the cut level or the number of objects. For example, instead of setting the switch point at cut level 5, the switch point could be based on when the number of moveable objects in a given bin is 10,000 or less.

The CG and SOR algorithms are known in the art. For convenience, the pseudo code for these algorithms is given below.

Conjugate Gradient Algorithm:

compute r⁽⁰⁾ = b − Ax⁽⁰⁾ for initial guess x⁽⁰⁾
for i = 1, 2, ...

solve M * z⁽ⁱ⁻¹⁾ = r⁽ⁱ⁻¹⁾
δᵢ₋₁ = r⁽ⁱ⁻¹⁾ * z⁽ⁱ⁻¹⁾
if i = 1 then d⁽¹⁾ = z⁽⁰⁾
else βᵢ₋₁ = δᵢ₋₁/δᵢ₋₂

d⁽ⁱ⁾ = z⁽ⁱ⁻¹⁾ + βᵢ₋₁ * d⁽ⁱ⁻¹⁾

end if
q⁽ⁱ⁾ = A * d⁽ⁱ⁾
αᵢ = δᵢ₋₁/d⁽ⁱ⁾ * q⁽ⁱ⁾
x⁽ⁱ⁾ = x⁽ⁱ⁻¹⁾ + αᵢ * d⁽ⁱ⁾
r⁽ⁱ⁾ = r⁽ⁱ⁻¹⁾ − αᵢ * q(i)
check convergence

end for.

Successive Over-Relaxation:

choose an initial guess x⁽⁰⁾
for k = 1, 2, ...

for i = 1, 2, ..., n

σ = 0
for j = 1, 2, ..., i−1

σ = σ + a_{i,j} * xⱼ^{(k)}

end for
for j = i+1, ..., n

σ = σ + a_{i,j} * xⱼ^{(k-1)}

end for
σ = (bᵢ − σ)/a_{i,i}
xᵢ^{(k)} = xᵢ^{(k-1)} + ω * (σ − xᵢ^{(k-1)})

end for
check convergence

end for.

The values aᵢⱼ represent the elements of matrix A, and ω is a constant ranging from 0 to 2.

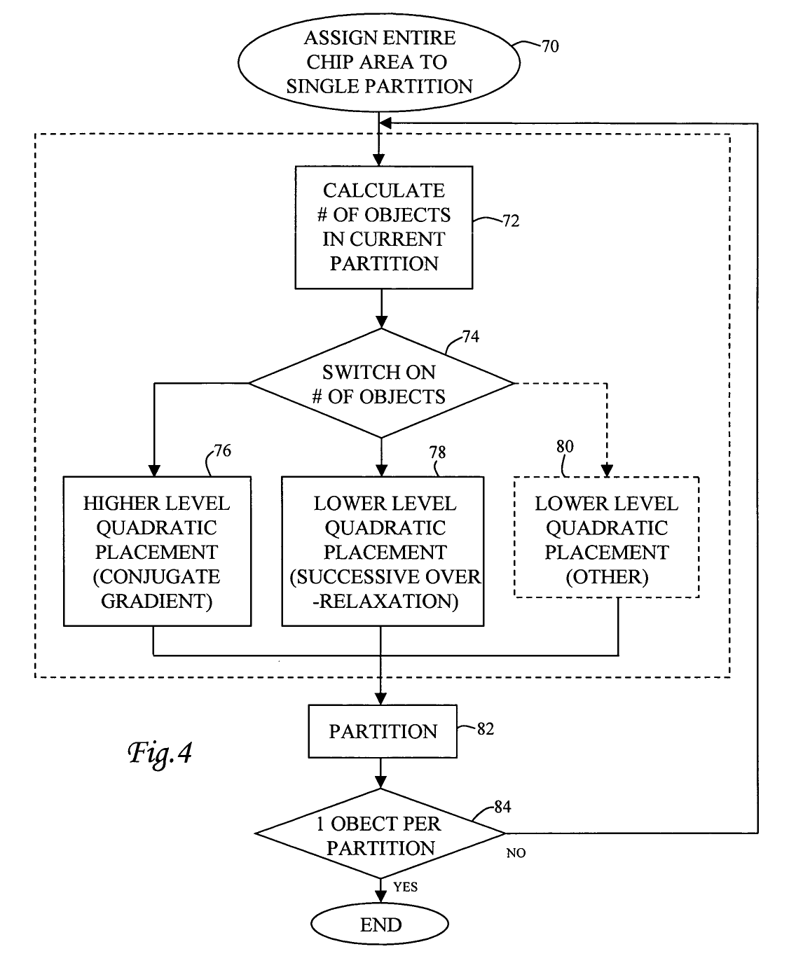

The invention may be further understood with reference to the flow chart of FIG. 4. The process begins by assigning the entire chip area to the initial partition (70). The number of moveable objects in the current partition is then calculated (72). A switch operation is then performed based on the number of current objects (74). If the number of objects is very high, then a higher-level quadratic placement algorithm (e.g., CG) is used to place the objects (76). If the number of objects is lower, then a lower level quadratic placement algorithm (e.g., SOR) is used to place the objects (78). The invention may optionally utilize more than two quadratic placement algorithms, e.g., if the number of objects in the current bin is particularly low, then some other quadratic placement algorithm could be used (80). Those skilled in the art will appreciate that the invention is not limited to the use of the CG and SOR techniques. Indeed, if a new linear system solving algorithm were to be conceived for use with very high numbers of objects, then that algorithm could be used for the first several cuts instead of the CG algorithm. After placement, the region is partitioned using bisection or quadrisection (82); other types of partitioning could be alternatively utilized. A check is made to see if the number of objects in the bin has reached the minimum threshold, e.g., one (84). If so, the process ends, otherwise the process repeats iteratively at step 72.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. It is therefore contemplated that such modifications can be made without departing from the spirit or scope of the present invention as defined in the appended claims.

1. A method of designing a layout of an integrated circuit, comprising the steps of:
first placing a plurality of logic cells in an initial region of the integrated circuit using a first placement algorithm;
partitioning the initial region into two or more partitioned regions; and
second placing a portion of the logic cells in at least one of the partitioned regions using a second placement algorithm which is different from the first placement algorithm.

2. The method of claim 1 wherein the first and second placement algorithms are quadratic placement algorithms.

3. The method of claim 2 wherein one of the first or second placement algorithms is a conjugate gradient placement algorithm.

4. The method of claim 2 wherein one of the first or second placement algorithms is a successive over-relaxation placement algorithm.

5. The method of claim 2 wherein:
the first placement algorithm is a conjugate gradient placement algorithm; and
the second placement algorithm is a successive over-relaxation placement algorithm.

6. The method of claim 1 further comprising the steps of:
second partitioning one of the partitioned regions into two or more partitioned sub-regions; and
third placing a portion of the logic cells in at least one of the partitioned sub-regions using a third placement algorithm which is different from the first and second placement algorithms.

7. The method of claim 1 wherein the first placement algorithm is more computationally efficient than the second placement algorithm.

8. A computer system comprising:
means for processing program instructions;
a memory device connected to said processing means; and
program instructions residing in said memory device for designing a layout of an integrated circuit, wherein said program instructions first place a plurality of logic cells in an initial region of the integrated circuit using a first placement algorithm, partition the initial region into two or more partitioned regions, and second place a portion of the logic cells in at least one of the partitioned regions using a second placement algorithm which is different from the first placement algorithm.

9. The computer system of claim 8 wherein the first and second placement algorithms are quadratic placement algorithms.

10. The computer system of claim 9 wherein one of the first or second placement algorithms is a conjugate gradient placement algorithm.

11. The computer system of claim 9 wherein one of the first or second placement algorithms is a successive over-relaxation placement algorithm.

12. The computer system of claim 9 wherein:
the first placement algorithm is a conjugate gradient placement algorithm; and
the second placement algorithm is a successive over-relaxation placement algorithm.

13. The computer system of claim 8 wherein said program instructions further second partition one of the partitioned regions into two or more partitioned sub-regions, and third place a portion of the logic cells in at least one of the partitioned sub-regions using a third placement algorithm which is different from the first and second placement algorithms.

14. The computer system of claim 8 wherein the first placement algorithm is more computationally efficient than the second placement algorithm.

15. A computer program product comprising:
a computer-readable medium; and
program instructions residing in said medium for designing a layout of an integrated circuit, wherein said program instructions first place a plurality of logic cells in an initial region of the integrated circuit using a first placement algorithm, partition the initial region into two or more partitioned regions, and second place a portion of the logic cells in at least one of the partitioned regions using a second placement algorithm which is different from the first placement algorithm.

16. The computer program product of claim 15 wherein the first and second placement algorithms are quadratic placement algorithms.

17. The computer program product of claim 16 wherein one of the first or second placement algorithms is a conjugate gradient placement algorithm.

18. The computer program product of claim 16 wherein one of the first or second placement algorithms is a successive over-relaxation placement algorithm.

19. The computer program product of claim 16 wherein:
the first placement algorithm is a conjugate gradient placement algorithm; and
the second placement algorithm is a successive over-relaxation placement algorithm.

20. The computer program product of claim 15 wherein said program instructions further second partition one of the partitioned regions into two or more partitioned sub-regions, and third place a portion of the logic cells in at least one of the partitioned sub-regions using a third placement algorithm which is different from the first and second placement algorithms.

21. The computer program product of claim 15 wherein the first placement algorithm is more computationally efficient than the second placement algorithm.
